(19) United States
(12) Patent Application Publication
(10) Pub. No.: US 2023/0019162 A1
(43) Pub. Date: Jan. 19, 2023

(54) CRANE, CRANE BODY, AND NON-TRANSITORY COMPUTER READABLE MEDIUM STORING PROGRAM

(71) Applicant: SUMITOMO HEAVY INDUSTRIES CONSTRUCTION CRANES CO., LTD., Tokyo (JP)

(72) Inventors: Minoru Toida, Tokyo (JP); Kohei Honjo, Aichi (JP)

(21) Appl. No.: 17/951,881

(22) Filed: Sep. 23, 2022

Related U.S. Application Data
(63) Continuation of application No. PCT/JP2021/012862, filed on Mar. 26, 2021.

(30) Foreign Application Priority Data
Mar. 27, 2020 (JP) 2020-057207

(51) Int. Cl. B66C 13/46; B66C 13/48; B64C 39/02; B64D 47/00; G05D 1/02

(52) U.S. Cl. CPC B66C 13/46; B66C 13/48; B64C 39/024; B64D 47/00; G05D 1/0246; G05D 1/0276; B64C 2201/128; B64C 2201/141; G05D 2201/0202

(57) ABSTRACT

A crane includes a crane body, a flying body, a route information acquisition unit that acquires route information in transporting a suspended load of the crane body via the flying body, and a support unit that performs steering support for performing a transport operation of the crane body along a movement route indicated by the route information.

### RELATED APPLICATIONS

The contents of Japanese Patent Application No. 2020-057207, and of International Patent Application No. PCT/JP2021/012862, on the basis of each of which priority benefits are claimed in an accompanying application data sheet, are in their entirety incorporated herein by reference.

### BACKGROUND

### Technical Field

Certain embodiments of the present invention relate to a crane, a crane body, and a non-transitory computer readable medium storing a program for appropriately transporting a suspended load.

### Description of Related Art

In related-art cable cranes, accurate transport has been realized by providing GPS receivers in a bucket that stores a suspended load and a transport destination, respectively, and lowering the suspended load when the position of the bucket and the destination have approached each other.

### SUMMARY

According to an embodiment of the present invention, there is provided a crane including a crane body; a flying body; a route information acquisition unit that acquires route information in transporting a suspended load of the crane body via the flying body; and a support unit that performs steering support for performing a transport operation of the crane body along a movement route indicated by the route information.

Additionally, another aspect of the invention has a configuration in which a crane body performs steering support for performing a transport operation along a movement route indicated by route information in transporting a suspended load of the crane body, which is acquired by a flying body.

Additionally, still another aspect of the invention has a configuration in which a non-transitory computer readable medium storing a program causes a computer to function as a route information acquisition unit that acquires route information in transporting a suspended load of a crane body via a flying body; and a support unit that performs steering support for performing a transport operation of the crane body along a movement route indicated by the route information.

### BRIEF DESCRIPTION OF DRAWINGS

FIG. 1 is a view showing a schematic configuration of a crane according to an embodiment of the present invention.

FIG. 2 is a block diagram showing a control system of a flying body.

FIG. 3 is a block diagram of a steering device.

FIG. 4 is an explanatory diagram showing a captured image when positional information of a departure point and of a destination is acquired by searching.

FIG. 5 is a flowchart when the positional information of the departure point and of the destination is acquired by the searching.

FIG. 6 is an explanatory diagram showing a case where an interference area is set from an image of a suspended load in a suspended state.

FIG. 7 is a flowchart showing control of the flying body by a second flight control unit.

FIG. 8 is a view of an operation of the flying body by the second flight control unit as seen from above.

FIG. 9 is a flowchart showing control of the flying body by a first flight control unit.

FIG. 10 is an explanatory diagram showing the disposition of the departure point, the destination, a crane body, and obstacles from above.

FIG. 11 is a perspective view of the crane body.

FIG. 12 is a block diagram showing a control system of a crane terminal.

FIG. 13 is an explanatory diagram showing an editing screen by a route editing unit.

FIG. 14 is an explanatory diagram showing a display example of a navigation message by an information providing unit.

FIG. 15 is a block diagram of a computer that executes some functional configurations performed by a control unit of the flying body and by a controller of the crane terminal.

### DETAILED DESCRIPTION

However, the bucket moves along the cable. Thus, it is possible to cope with only transport of which a route is determined to be constant, and the above related art could not be applied to the transport of suspended loads in an environment where the route fluctuates as necessary.

It is desirable to transport a suspended load along an appropriate route.

According to the present invention, it is possible to transport the suspended load along an appropriate route.

### Schematic Configuration of Crane

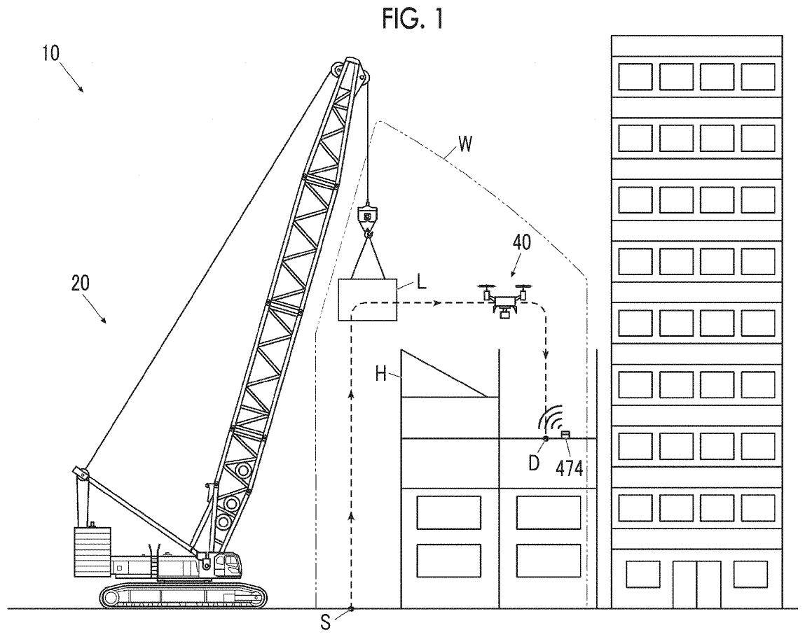

FIG. 1 is a view showing a schematic configuration of a crane according to an embodiment of the present invention. As shown in FIG. 1, a crane 10 mainly includes a crane body 20 and a flying body 40, and the crane body 20 transports a suspended load on the basis of route information acquired by using the flying body 40.

### Flying Body

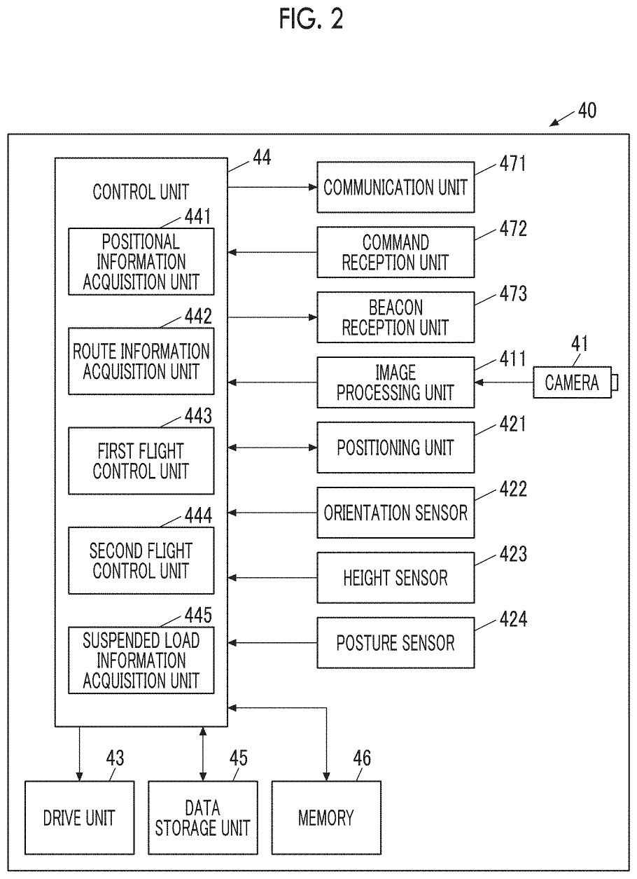

FIG. 2 is a block diagram showing a control system of the flying body 40.

The flying body 40 is an airframe referred to as a so-called drone that has a plurality of rotors, and can fly, freely move upward and downward, move forward, backward, leftward, and rightward, turn forward and backward, and so on by controlling the output of a motor serving as a drive source for each rotor.

The flying body 40 flies between a departure point S and a destination D in transporting the suspended load via the crane body 20 and acquires the route information thereof.

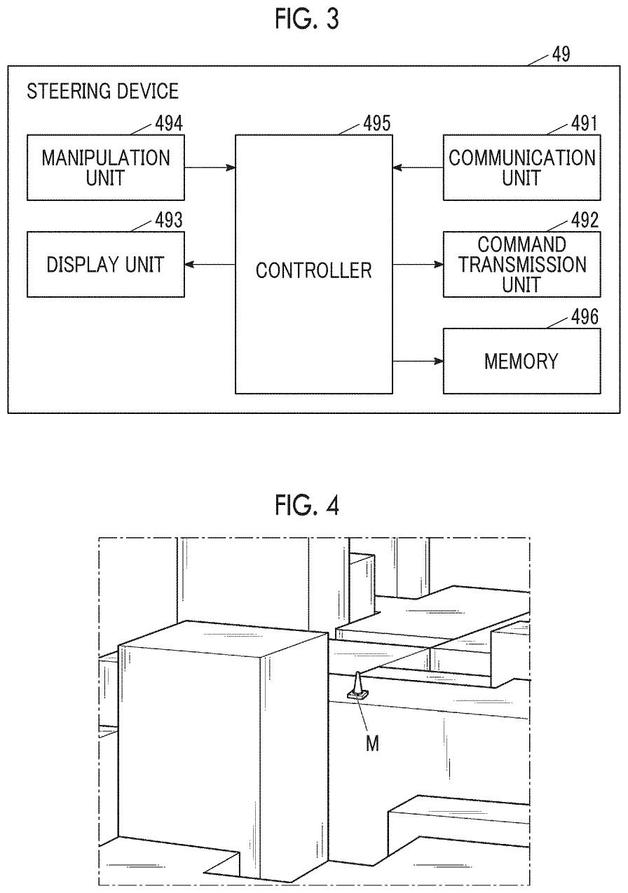

Additionally, the flying body 40 can select an autonomous flight mode in which the flying body flies between the departure point S and the destination D via autonomous flight, and a steering mode in which the flying body flies in accordance with steering by a worker using a steering device 49 shown in FIG. 3.

As shown in FIG. 2, the flying body 40 includes a camera 41 as an imaging device, a positioning unit 421, an orientation sensor 422, a height sensor 423, a posture sensor 424, a drive unit 43, a control unit 44, a data storage unit 45, a memory 46, a communication unit 471, a command reception unit 472, and a beacon reception unit 473.

In addition, sensors such as the camera 41, the positioning unit 421, the orientation sensor 422, the height sensor 423, the posture sensor 424, and the like described above are only examples, and the flying body 40 may be configured such that some of the sensors are not mounted thereon.

The camera 41 is supported facing a front side determined for the airframe of the flying body 40, and captures a scene ahead of the line of sight depending on the direction of the airframe. The camera 41 can acquire captured images continuously at a certain frame rate. Accordingly, it is possible to image the surrounding situations on the route between the departure point S and the destination D in transport. An image signal obtained by the imaging is output to an image processing unit 411 connected to the camera 41, and the image processing unit 411 generates captured image data in a predetermined format and records the generated image in the memory 46.

The camera 41 is not limited to acquiring images of visible light, and an infrared camera imaging infrared light may be used. In a case where the infrared camera is used, distance image data can be obtained by a phase contrast method or the like.

Additionally, a stereo camera may be used instead of a monocular camera. Also in this case, it is possible to obtain the distance image data.

In addition, it is also possible to obtain the distance image data from captured images captured from two spots close to each other by the monocular camera, not limited to the stereo camera or the infrared camera.

The positioning unit 421 is a global navigation satellite system (GNSS) receiver such as a global positioning system (GPS), and measures a three-dimensional current position of the flying body 40.

The orientation sensor 422 is a triaxial gyro azimuth angle sensor that detects a traveling direction of the flying body 40 and an inclined angle of the airframe.

The height sensor 423 is, for example, an optical type, projects light downward, and detects the height of the airframe from a phase difference occurring in the reflected light.

The posture sensor 424 is composed of a three-dimensional acceleration sensor and detects accelerations in respective directions of the X-axis, Y-axis, and Z-axis determined for the flying body 40. The posture of the airframe can be detected from the gravitational acceleration detected for each of these axes.

The communication unit 471 is composed of a wireless data communication device, and performs wireless communication with a crane terminal 30 of the crane body 20 and the steering device 49. The communication unit 471 may be a data communication device capable of wireless communication only with the crane terminal 30 and the steering device 49, or may be a data communication device that performs communication through a network line via a base station.

The communication unit 471 mainly executes transmission of image data captured by the camera 41 to the crane terminal 30 and to the steering device 49, and transmission of data of route information (to be described below) acquired by the flying body 40 to the crane terminal 30.

The command reception unit 472 is a wireless reception device, and receives a steering command output from the steering device 49.

The beacon reception unit 473 is a reception device that receives an output signal from a beacon transmitter 474 (see FIG. 1) installed at the departure point S and at the destination D in transporting a suspended load L. The beacon transmitter 474 includes a GNSS receiver such as a GPS, and a signal output unit. The GNSS receiver acquires the positional information of the installation position where the beacon transmitter 474 is installed, and wirelessly transmits the positional information as a current position transmission signal. The beacon reception unit 473 can receive and acquire the positional information of the destination D transmitted by the beacon transmitter 474.

The drive unit 43 is configured to output a thrust force for moving and operating the flying body 40, and has a plurality of rotors and a plurality of motors serving as rotation drive sources provided for each rotor. Each motor is controlled by the control unit 44 such that the airframe moves in a target movement direction.

The data storage unit 45 is a non-volatile storage device that stores a control program for the flying body 40 and various types of information related to control.

The memory 46 stores the captured image data captured by the camera 41. A semiconductor memory or the non-volatile storage device can be used for the memory 46.

### Flying Body: Steering Device

FIG. 3 is a block diagram of the steering device 49 of the flying body 40. As shown in FIG. 3, the steering device 49 includes a communication unit 491, a command transmission unit 492, a display unit 493, a manipulation unit 494, a controller 495, and a memory 496.

The communication unit 491 is composed of a wireless data communication device and receives the captured image data from the flying body 40. The received captured image data is stored in the memory 496 which is a semiconductor memory or a non-volatile storage device.

The communication unit 491 may be a data communication device capable of wireless communication only with the flying body 40, or may be a data communication device that performs communication through a network line via a base station.

The manipulation unit 494 is an input device including a steering stick and a switch, and can input operations such as forward movement, backward movement, leftward movement, rightward movement, ascending, descending, left turning, right turning, hovering, and the like of the flying body 40. Additionally, the manipulation unit 494 can input the selection of the autonomous flight mode and the steering mode of the flying body 40, the starting and stopping of the flying body 40, and the like.

The command transmission unit 492 is a wireless transmission device, and transmits a steering command according to the operation input from the manipulation unit 494 to the command reception unit 472 of the flying body 40.

The display unit 493 is a display for displaying the captured images based on the captured image data received from the flying body 40.

The controller 495 is configured to include an arithmetic processing device having a CPU, a ROM and a RAM which are storage devices, and other peripheral circuits.

Also, the controller 495 executes the control of displaying the captured images on the display unit 493, the control of transmitting the steering command based on the input from the manipulation unit 494, the processing of storing the captured image data received from the flying body 40 into the memory 496, and the like.

With the above configuration, in the steering mode, the steering device 49 displays the captured images by the camera 41 of the flying body 40 on the display unit 493 in real time, and allows a user to steer the flying body 40 while viewing the captured images.

### Flying Body: Control Unit

The control unit 44 includes a positional information acquisition unit 441, a route information acquisition unit 442, a first flight control unit 443, a second flight control unit 444, and a suspended load information acquisition unit 445. These units are functional configurations realized by executing a program in the data storage unit 45 via a central processing device provided in the control unit 44.

In addition, the positional information acquisition unit 441, the route information acquisition unit 442, the first flight control unit 443, the second flight control unit 444, and the suspended load information acquisition unit 445 are not limited to a case where the units are functional configurations realized by programs, and may be constituted by dedicated circuits or chips that execute the respective functions.

### Control Unit: Positional Information Acquisition Unit

The positional information acquisition unit 441 acquires the positional information of the departure point S and of the destination D in advance in order to obtain the route information from the departure point S to the destination D for transporting the suspended load L in the route information acquisition unit 442.

In addition, in a case where the flying body 40 starts flying from the departure point S, a configuration may be adopted in which only the positional information of the destination D is acquired.

As shown in FIG. 1, the departure point S is a place where the suspended load L is prepared in advance, and slinging work of the suspended load L is performed on a main hook 244 of the crane body 20 at the departure point S.

The destination D is a place where the suspended load L is transported, and unslinging work of the suspended load L is performed from the main hook 244 of the crane body 20.

In addition, in a case where the departure point S or the destination D and the crane body 20 are extremely close to each other, the position of the crane body 20 may be regarded as the departure point S or the destination D.

The method of acquiring the positional information of the departure point S and of the destination D via the positional information acquisition unit 441 includes (1) acquisition of input information by the worker, (2) acquisition by the current position transmission signal, (3) acquisition by search, and the like.

In addition, the positional information acquisition unit 441 may be configured to execute only any one of the above (1) to (3) or to execute a preselected method that makes these selectable, or may be configured to determine priority on the above (1) to (3) and to sequentially execute the above (1) to (3) in accordance with the priority until the positional information is acquired.

### (1) In Case of Acquisition of Input Information by Worker

For example, in a case where the positional information such as the position coordinates of the departure point S and of the destination D is set and input from the input unit 331 of the crane terminal 30, which will be described below, and the positional information is held, the positional information acquisition unit 441 transmits request commands for the positional information of the departure point S and of the destination D to the crane terminal 30 through the communication unit 471, and acquires the request commands from the crane terminal 30.

In addition, the steering device 49 may be provided with an input unit for inputting the positional information such as the position coordinates of the departure point S and of the destination D, and the positional information acquisition unit 441 may be configured to acquire the positional information of the departure point S and of the destination D from the steering device 49.

### (2) Acquisition by Current Position Transmission Signal

In this case, as shown in FIG. 1, the positional information acquisition unit 441 receives and acquires the positional information of the installation position transmitted from the beacon transmitter 474 installed at the departure point S and at the destination D via the beacon reception unit 473.

### (3) Acquisition by Search

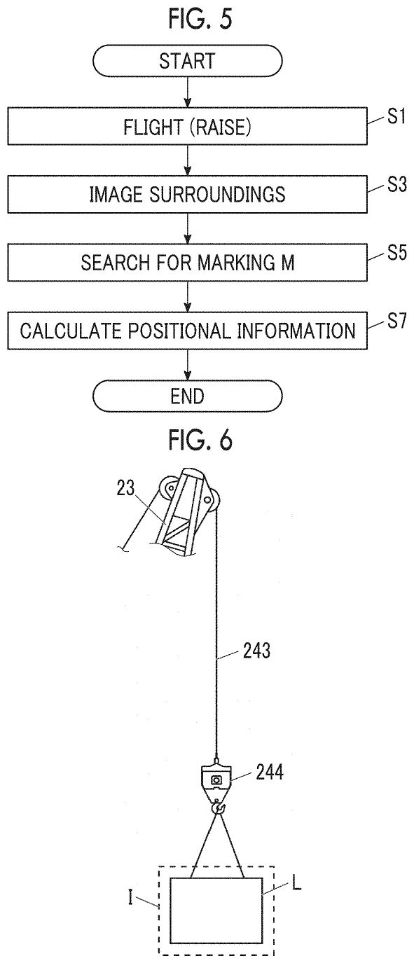

FIG. 4 is an explanatory diagram showing a captured image when the acquisition by search is performed, and FIG. 5 is a flowchart showing processing executed by the positional information acquisition unit 441 when the acquisition by search is performed.

In this case, the positional information acquisition unit 441 searches for a marking M installed at the departure point S or at the destination D with the camera 41 of the flying body 40, as shown in FIG. 4.

That is, the positional information acquisition unit 441 sequentially captures images of the surroundings (Step S3) in a state in which the drive unit 43 is controlled to raise the flying body 40 to a specified height (Step S1). Then, an image of the marking M is searched for in the obtained captured image (Step S5). This determination may be performed using pattern matching or machine learning techniques.

Meanwhile, since the camera 41 continuously acquires the captured images at a certain frame rate, the positional information acquisition unit 441 calculates three-dimensional position coordinates of the marking M from the frame images before and after the image of the marking M is present and the position coordinates of the flying body 40 when each frame image obtained from the positioning unit 421 are captured. That is, the three-dimensional coordinates of the marking M can be calculated by extracting the marking M in the range of preceding and succeeding frame images and specifying the position of the marking M within each frame image.

Accordingly, the positional information acquisition unit 441 can obtain the position coordinates of the marking M and acquire the positional information of the departure point S or of the destination D.

### Control Unit: Route Information Acquisition Unit

The route information acquisition unit 442 sequentially records the position of the flying body 40 when flying from the departure point S to the destination D regardless of being in the autonomous flight mode or the steering mode, and acquires the route information in transporting the suspended load L via the crane body 20.

That is, in a case where the flying body 40 is flying from the departure point S to the destination D in the autonomous flight mode or in the steering mode on the basis of the positional information of the departure point S and of the destination D acquired by the positional information acquisition unit 441, the detection position of the flying body 40 detected by the positioning unit 421 is recorded at minute sampling intervals.

Accordingly, the route information acquisition unit 442 can acquire route information composed of the position coordinates of a plurality of points continuously lined up on the route from the departure point S to the destination D.

### Control Unit: Suspended Load Information Acquisition Unit

A second flight control unit 444, which will be described below, sets an interference area I centered on the flying body 40 on the basis of the size of the suspended load L, and controls the flying body 40 so as to execute a flight in which the interference area I does not interfere with surrounding obstacles.

The suspended load information acquisition unit 445 acquires information (referred to as suspended load information) on the size of the suspended load L for setting the interference area I via the second flight control unit 444.

Methods of acquiring the suspended load information via the suspended load information acquisition unit 445 include (1) acquisition of input information by the worker, (2) acquisition by imaging with the camera 41 of the flying body 40, and the like.

In addition, the suspended load information acquisition unit 445 may be configured to execute only any one of the above (1) or (2) or to execute a preselected method that makes these selectable, or may be configured to determine priority on the above (1) or (2) and to sequentially execute the above (1) or (2) in accordance with the priority until the suspended load information is acquired.

### (1) In Case of Acquisition of Input Information by Worker

For example, in a case where the up-down, left-right, and front-rear dimensions of the suspended load L are input from the input unit 331 of the crane terminal 30 and are held as the suspended load information, the suspended load information acquisition unit 445 transmits a request command for the suspended load information to the crane terminal 30 through the communication unit 471, and acquires the request command from the crane terminal 30.

Also in this case, the steering device 49 may be provided with an input unit for the suspended load information, and the positional information acquisition unit 441 may be configured to acquire the suspended load information from the steering device 49.

(2) Acquisition by Imaging with Camera 41 of Flying Body 40

In this case, the suspended load information acquisition unit 445 causes the flying body 40 to fly to the crane body 20, and causes the flying body 40 to image the suspended load L in a suspended state as shown in FIG. 6. As described below, the crane body 20 includes a positioning unit 324 and can detect its own position. Thus, the positional information of the crane body 20 can be acquired by the flying body 40. Accordingly, it is possible to fly to the location of the crane body 20 and to image the crane body 20 with the camera 41 of the flying body 40. The flying body 40 captures an image of each part of the crane body 20, searches for, for example, the main hook 244 from the acquired captured image via a technique such as pattern matching, and specifies the suspended load L attached to the main hook 244. The suspended load information, which are the up-down, left-right, and front-rear dimensions of the suspended load L can be acquired by imaging the suspended load L from multiple directions and by performing comparison with a member having known dimensions (for example, the main hook 244).

In addition, the worker may transport the flying body 40 to the crane body 20 to image the suspended load L. Even in that case, it is preferable to acquire the positional information of the crane body 20 during imaging from the crane terminal 30.

### Control Unit: Second Flight Control Unit

The second flight control unit 444 performs the control of setting the interference area I centered on the flying body 40 on the basis of the size of the suspended load L and causes the flying body 40 to execute a flight in which the interference area I does not interfere with surrounding obstacles, in a case where the flying body 40 flies between the departure point S and the destination D regardless of being in the autonomous flight mode or the steering mode.

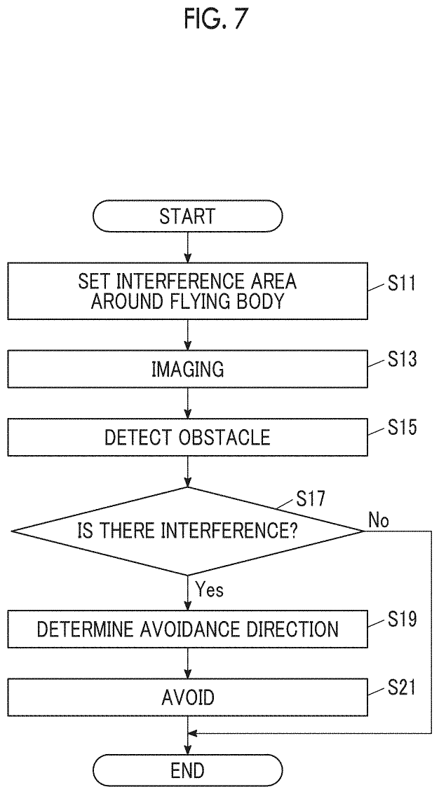

Specifically, as shown in a flowchart of FIG. 7, the second flight control unit 444 virtually sets a three-dimensional interference area I (see FIG. 6), having a size equal to or having a slight margin with respect to the dimension of the suspended load L on the basis of the suspended load information of the suspended load information acquisition unit 445 during flight, around the flying body 40 (Step S11). In this case, the center of the flying body 40 and the center of the interference area I are made to coincide with each other.

Then, a scene in front of the flying body 40 is imaged by the camera 41 (Step S13), and an obstacle H within the field of view is detected from the captured image (Step S15). That is, in this case, the camera 41 functions as an obstacle detection unit.

As previously mentioned, the camera 41 continuously acquires captured images at a certain frame rate. Thus, the second flight control unit 444 can extract feature points in the continuous frame images captured by the camera 41 during flight, and calculate the three-dimensional position coordinates of each feature point from the position coordinates of the flying body 40 when each frame image obtained by the positioning unit 421 is captured. In a case where the respective feature points are angular portions of the obstacle H composed of a structure located in front of the flying body 40, the range of the obstacle H in space can be defined by connecting these feature points, and the three-dimensional positional information of the obstacle H can be detected.

Then, the second flight control unit 444 collates the three-dimensional interference area I centered on the flying body 40 with the three-dimensional positional information of the obstacle H, and determines whether or not interference occurs between the obstacle H and the interference area I when the flying body 40 travels as is (Step S17), and the flying body 40 travels as is and the processing is ended in a case where no interference occurs.

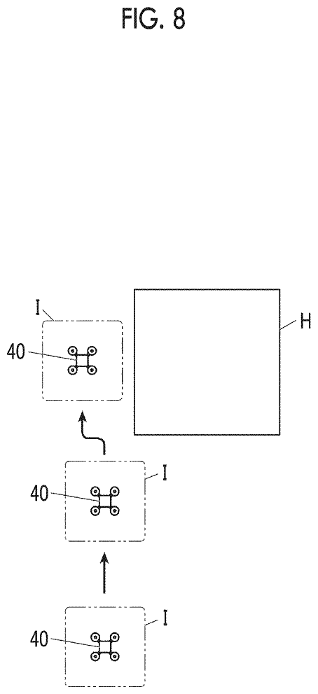

Additionally, in a case where interference occurs, a direction in which interference is avoided is determined (Step S19), and as shown in FIG. 8, the interference is avoided, and the airframe moves in the direction in which interference is avoided and continues to travel (Step S21). Then, the processing is ended.

In addition, the above processing of the above second flight control unit 444 is repeatedly executed in a short period of time during the flight of the flying body 40.

### Control Unit: First Flight Control Unit

The first flight control unit 443 executes the control of causing the flying body 40 to fly between the departure point S and the destination D in the autonomous flight mode.

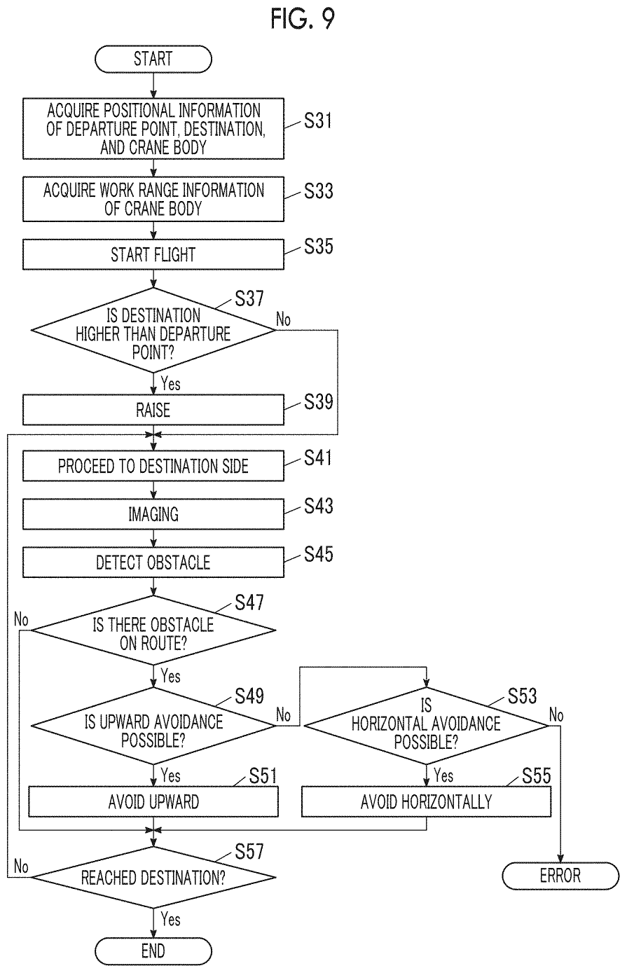

Specifically, as shown in a flowchart of FIG. 9, the first flight control unit 443 first acquires the positional information of the departure point S and of the destination D from the positional information acquisition unit 441, and acquires the positional information of the crane body 20 from the crane terminal 30 during transport (Step S31). The crane terminal 30 includes the positioning unit 324 and acquires current positional information of the crane body 20 detected by the positioning unit 324 through communication of the communication unit 471.

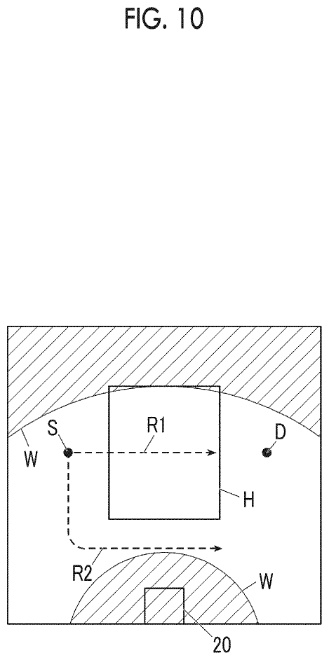

Moreover, the first flight control unit 443 acquires the work range information of the crane body 20 from the crane terminal 30 (Step S33). In the crane terminal 30, a derricking angle of a boom 23 is limited within a certain angle range depending on the length of the boom 23 of the crane body 20, the weight of the suspended load L, and the like, which will be described below. Therefore, a work range W of the crane body 20 is determined depending on the turning of a rotating platform 22 of the crane body 20 and on an angle range in which the boom 23 is derrickable, which will be described below (see FIGS. 1 and 10). A work range setting unit 313 of the crane terminal 30, which will be described below, calculates the work range of the crane body 20 from the above various conditions and holds the work range as the work range information.

The first flight control unit 443 requests and acquires the work range information of the crane body 20 from the crane terminal 30 through the communication of the communication unit 471.

After the above information is acquired, the first flight control unit 443 causes the flying body 40 to start flight (Step S35). In this case, in a case where the destination D is at a higher position than the departure point S (Step S37), the flying body 40 is raised to the height of the destination D (Step S39), and in a case where the destination D is not higher than the departure point S, the current height is maintained.

Then, the flying body 40 is caused to fly horizontally toward the destination D side (Step S41), and the imaging by the camera 41 is started (Step S43).

Then, the obstacle H on the course is detected from the captured image (Step S45). The detection of the obstacle H is performed by the same technique as that of the above-mentioned second flight control unit 444. That is, the feature points in the continuous frame images captured by the camera 41 are extracted, the three-dimensional position coordinates of each feature point are obtained, and the three-dimensional positional information of the obstacle H in the space is detected by connecting these coordinates to each other.

The first flight control unit 443 determines whether or not there is an obstacle H ahead in the traveling direction (Step S47), and the processing proceeds to Step S57 in a case where there is no obstacle H.

Additionally, in a case where there is an obstacle H ahead in the traveling direction, it is determined whether or not it is possible to avoid the obstacle H upward (Step S49).

FIG. 10 is an explanatory diagram showing the disposition of the departure point S, the destination D, the crane body 20, and the obstacle H from above. Reference numeral W shown in FIGS. 1 and 10 indicates the work range of the crane body 20. In FIG. 10, the outside of the work range W is masked with oblique lines.

As shown in FIG. 10, in a case where the flying body 40 selects a route R1 along which the flying body 40 avoids the obstacle H upward, and in a case where the upward avoidance route R1 of the flying body 40 is inside the work range W of the crane body 20, the first flight control unit 443 determines that upward avoidance is possible, and then selects the upward avoidance route R1 (Step S51).

Additionally, in a case where the upward avoidance route R1 is outside the work range W of the crane body 20, whether or not horizontal avoidance is possible is determined depending on whether or not a horizontal avoidance route R2 along which the flying body 40 goes around the obstacle H along a horizontal plane is on the side of the work range W of the crane body 20 (Step S53).

In addition, there is a case where the horizontal avoidance route R2 of the obstacle H includes a route closer to the crane body 20 and a route passing a side farther from the crane body 20. In that case, a route that will be the work range W is selected. Additionally, in a case where both the routes are selectable, a setting such as selecting the closer route may be made in advance.

In a case where the horizontal avoidance route R2 cannot be selected in the above determination, the current disposition of the crane body 20 makes it impossible to avoid the obstacle H and to transport the suspended load L, and ends with an error. Notification of the occurrence of the error may be sent to the crane terminal 30 or to the steering device 49. Additionally, the flying body 40 may be controlled to return to the departure point S in the event of the error.

On the other hand, in a case where the horizontal avoidance route R2 of the flying body 40 is inside the work range W of the crane body 20, the first flight control unit 443 selects the horizontal avoidance route R2 (Step S55).

Then, the first flight control unit 443 determines whether or not the flying body 40 has reached the destination D (Step S57), and lowers and lands the flying body 40 to end the control in a case where the flying body 40 has reached the destination D.

Additionally, in a case where the flying body 40 has not reached the destination D, the processing returns to Step S41 where the flying body 40 flies toward the destination D from a position after the avoidance and detects a new obstacle H.

In addition, while the flight control of the flying body 40 is being executed by the first flight control unit 443, the above-mentioned flight control by the second flight control unit 444 is also executed in parallel. For this reason, in a case where the second flight control unit 444 detects any interference with the interference area I when the flying body 40 passes the vicinity of the obstacle H in accordance with the control of the first flight control unit 443, the operation of avoiding the obstacle H while maintaining the traveling direction under the control of the first flight control unit 443 is executed in parallel.

Additionally, even during the flight of the flying body 40, the route information acquisition unit 442 records the detection position of the flying body 40 detected by the positioning unit 421 at minute sampling intervals, and generates the route information from the departure point S to the destination D.

### Control Unit: Processing In Steering Mode

Additionally, as previously mentioned, the flying body 40 can be caused to fly from the departure point S to the destination D in the steering mode by the steering device 49.

In this case, the worker can cause the flying body 40 to fly through manual steering from the departure point S to the destination D while viewing the image captured by the camera 41 of the flying body 40 on the display unit 493 of the steering device 49.

During the flight in the steering mode, the control unit 44 always determines whether or not the flying body 40 is within the work range W of the crane body 20, and executes a limiting control such that the flying body 40 flies within the work range W. For example, control such as stopping the traveling of the flying body 40 toward the outside of the work range W at the boundary of the work range W is executed. Additionally, in that case, the steering device 49 may be notified that the flying body 40 is heading for the outside of the work range W.

Moreover, even during the flight in the steering mode, the route information acquisition unit 442 records the detection position of the flying body 40 at minute sampling intervals to acquire the route information in transporting the suspended load L of the crane body 20, and the flight control by the second flight control unit 444 is also executed in parallel.

Therefore, by causing the flying body 40 to fly from the departure point S to the destination D in the steering mode, it is possible to avoid the obstacle H in the set interference area I and to generate the route information within the work range.

### Crane Body

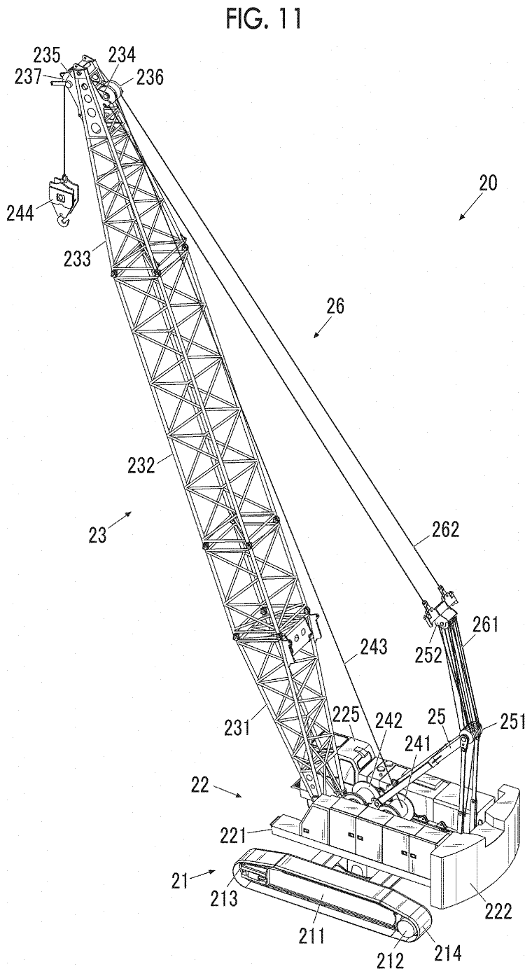

FIG. 11 is a perspective view of the crane body 20.

The crane body 20 will be described with reference to FIG. 11. Here, as the crane body 20, a so-called mobile crawler crane is exemplified. Regarding the description of the crane body 20 below, a forward direction of the crane body 20 (predetermined forward direction of a lower traveling body 21 regardless of a direction in which the rotating platform 22 faces) is referred to as “front”, a backward direction thereof is referred to as “rear”, a left-hand side in a state in which the crane body faces forward is referred to as “left”, and a right-hand side in a state in which the crane body faces forward is referred to as “right”.

In addition, the crane body 20 can select an autonomous operation mode in which the suspended load L is transported by autonomous control, and the steering mode in which the suspended load L is transported in accordance with the steering by the worker on board.

In FIG. 11, the crane body 20 is configured to include the self-propelled crawler-type lower traveling body 21, the rotating platform 22 turnably mounted on the lower traveling body 21, and the boom 23 attached to a front side of the rotating platform 22 so as to be derrickable.

The lower traveling body 21 includes a truck frame 211, drive wheels 212 and idler wheels 213 provided on both left and right sides of the truck frame 211, and crawler belts 214 wound around the drive wheels 212 and the idler wheels 213. The left and right drive wheels 212 are rotationally driven by traveling hydraulic motors (not shown), respectively.

The rotating platform 22 has a turning frame 221 that extends in the forward and rearward directions. A lower end portion of the boom 23 is supported on the front side of the turning frame 221. Additionally, a lower end portion of a gantry 25 is supported behind a boom support position on the turning frame 221.

Additionally, the rotating platform 22 is driven to turn around a vertical axis with respect to the lower traveling body 21 by a turning hydraulic motor (not shown).

A counterweight 222 that balances the weight of the boom 23 and of the suspended load L is disposed at a rear portion of the turning frame 221. The number of counterweights 222 can be increased or decreased as necessary.

A boom derricking winch (not shown) is disposed immediately in front of the counterweight 222, and a main winding winch 241 and an auxiliary winding winch 242 are disposed in front of the boom derricking winch.

Additionally, a cab 225 is disposed on a right front side of the turning frame 221. The crane terminal 30, which will be described below, is disposed in an operation room within the cab 225.

The boom 23 is attached to the turning frame 221 of the rotating platform 22 so as to be derrickable. The boom 23 includes a lower boom 231, an intermediate boom 232, and an upper boom 233.

Sheave brackets 234 and 235 are provided at an upper end portion of the upper boom 233. A guide sheave 236 is rotatably attached to the sheave bracket 234, and a point sheave 237 is rotatably attached to the sheave bracket 235. A main winding rope 243 is wound around the guide sheave 236 and the point sheave 237.

The main winding winch 241 winds and unwinds the main winding rope 243 via a main winding hydraulic motor (not shown), and lifts and lowers the main hook 244 and the suspended load L.

The auxiliary winding winch 242 winds and unwinds an auxiliary winding rope (not shown) to which an auxiliary hook (not shown) is attached via an auxiliary winding hydraulic motor (not shown).

The gantry 25 has a lower end portion pivotably attached to a bracket (not shown) of the turning frame 221 by pin coupling and has an upper end portion pivotable in the front-rear direction. A lower boom spreader 251 having a plurality of sheaves is provided at an upper end portion of the gantry 25.

Meanwhile, a boom derricking rope 26 is constituted by a boom winding rope 261 and a boom pendant rope 262.

An upper end portion of the boom pendant rope 262 is connected to the upper end portion of the upper boom 233, and a lower end portion of the boom pendant rope 262 is provided with an upper boom spreader 252 having a plurality of sheaves.

The boom winding rope 261 is wound around the boom derricking winch on one end side and is wound around each sheave of the upper boom spreader 252 and each sheave of the lower boom spreader 251 on the other end side.

The boom derricking winch winds and unwinds the boom winding rope 261 via a derricking hydraulic motor (not shown) and adjusts the derricking angle of the boom 23 with respect to the turning frame 221.

### Crane Body: Crane Terminal

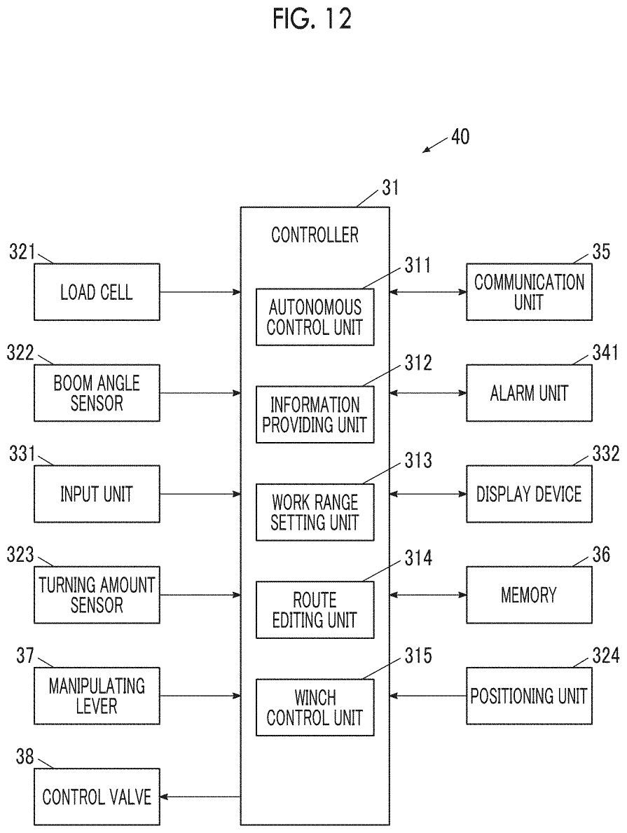

FIG. 12 is a block diagram showing the configuration of the crane terminal 30. The crane terminal 30 is a control terminal mounted on the crane body 20 and controls various operations of the crane body 20 such as traveling, turning, and load-suspending.

The crane terminal 30 includes a controller 31 configured to include an arithmetic processing device having a CPU, a ROM and a RAM that are storage devices, other peripheral circuits, and the like.

A load cell 321, a boom angle sensor 322, a turning amount sensor 323, the positioning unit 324, an input unit 331, the display device 332, an alarm unit 341, a communication unit 35, a manipulating lever 37, a control valve 38, and a memory 36 are connected to the controller 31.

The load cell 321 is attached to the upper boom spreader 252, detects the tension acting on the boom derricking rope 26 that derricks the boom 23, and outputs a control signal corresponding to the detected tension to the controller 31.

The input unit 331 is, for example, a touch panel, and outputs control signals corresponding to manipulations by the worker to the controller 31. The worker can manipulate the input unit 331 to set the length of the boom 23, the weight of the suspended load L, the selection of the autonomous operation mode or a manual mode, the positional information such as the position coordinates of the departure point S and of the destination D of the suspended load, and the like.

The boom angle sensor 322 is attached to a base end side of the boom 23, detects the derricking angle (hereinafter also referred to as boom angle) of the boom 23, and outputs a control signal corresponding to the detected boom angle to the controller 31. The boom angle sensor 322 detects, for example, a ground angle, which is an angle with respect to the horizontal plane, as the boom angle.

The turning amount sensor 323 is attached between the lower traveling body 21 and the rotating platform 22, detects a turning angle of the rotating platform 22, and outputs a control signal corresponding to the detected turning angle to the controller 31. The turning amount sensor 323 detects, for example, an angle around the vertical axis as the turning angle.

The positioning unit 324 is a GNSS receiver such as a GPS and measures the current position of the crane body 20.

The display device 332 includes, for example, a touch panel display that is also used as the input unit 331, and displays information such as the weight of the suspended load L, the boom angle, and the turning angle of the rotating platform 22 on a display screen on the basis of control signals output from the controller 31. Additionally, the image captured by the camera 41 of the flying body 40 can also be displayed.

The alarm unit 341 generates an alarm on the basis of a control signal output from the controller 31.

The communication unit 35 is composed of a wireless data communication device and performs wireless communication with the flying body 40. The communication unit 35 may be a data communication device capable of wireless communication only with the flying body 40, or may be a data communication device that performs communication through a network line via a base station.

The communication unit 35 receives the captured image data from the flying body 40 and the route information data acquired by the flying body 40. The received various data is stored in the memory 36 composed of a semiconductor memory or of a non-volatile storage device.

The control valve 38 is constituted by a plurality of valves that are switchable in accordance with control signals from the controller 31.

For example, the control valve 38 includes a valve that switches the supply and cut-off of hydraulic pressure from a hydraulic pump provided in the crane body 20 to the traveling hydraulic motor that performs the rotational driving of each drive wheel 212 of the lower traveling body 21, and the direction of rotation; a valve that switches the supply and cut-off of the hydraulic pressure from the hydraulic pump to the turning hydraulic motor that performs the turning operation of the rotating platform 22, and the direction of rotation; a valve that switches the supply and cut-off of the hydraulic pressure from the hydraulic pump to the derricking hydraulic motor that performs the rotational driving of the boom derricking winch, and the direction of rotation; a valve that switches the supply and cut-off of the hydraulic pressure from the hydraulic pump to the main winding hydraulic motor that performs the rotational driving of the main winding winch 241, and the direction of rotation; a valve that switches the supply and cut-off of the hydraulic pressure from the hydraulic pump to the auxiliary winding hydraulic motor that performs the rotational driving of the auxiliary winding winch 242, and the direction of rotation; and the like.

The manipulating lever 37 manually inputs, for example, a manipulation for causing the crane body 20 to perform various operations, and inputs a control signal corresponding to the manipulated variable of the manipulating lever 37 to the controller 31.

For example, a traveling lever, which is one of the manipulating levers 37, inputs a switching signal to the above-mentioned valve that switches the supply and stop of the hydraulic pressure to the traveling hydraulic motor that performs the rotational driving of each drive wheel 212 of the lower traveling body 21, and the direction of rotation.

Additionally, a turning lever, which is one of the manipulating levers 37, inputs a switching signal to the above-mentioned valve that switches the supply and stop of the hydraulic pressure from the hydraulic pump to the turning hydraulic motor that performs the turning operation of the rotating platform 22, and the direction of rotation.

Additionally, a boom derricking lever, which is one of the manipulating levers 37, inputs a switching signal to the above-mentioned valve that switches the supply and stop of the hydraulic pressure from the hydraulic pump to the derricking hydraulic motor that performs the rotational driving of the boom derricking winch, and the direction of rotation.

Additionally, a winding lever, which is one of the manipulating levers 37, inputs a switching signal to the above-mentioned valve that switches the supply and stop of the hydraulic pressure from the hydraulic pump to the main winding hydraulic motor that performs the rotational driving of the main winding winch 241, and the direction of rotation.

Additionally, an auxiliary winding lever, which is one of the manipulating levers 37, inputs a switching signal to the above-mentioned valve that switches the supply and stop of the hydraulic pressure from the hydraulic pump to the auxiliary winding hydraulic motor that performs the rotational driving of the auxiliary winding winch 242, and the direction of rotation.

### Controller

The controller 31 includes an autonomous control unit 311 as a crane control unit, an information providing unit 312, a work range setting unit 313, a route editing unit 314, and a winch control unit 315. These units are functional configurations realized by executing a program in the ROM via a central processing device provided in the controller 31.

In addition, the autonomous control unit 311, the information providing unit 312, the work range setting unit 313, the route editing unit 314, and the winch control unit 315 are not limited to the functional configurations realized by the program, and may be constituted by dedicated circuits or chips that execute the respective functions.

Additionally, the autonomous control unit 311 as the crane control unit, and the information providing unit 312 are both configured to correspond to a support unit that performs steering support for performing the transport operation of the crane body.

Additionally, the autonomous control that is performed by the autonomous control unit 311 and that allows the suspended load L to be transported along a route determined in the route information, which will be described below, and the control of autonomous return operation of returning the main hook 244 to the departure point S by tracing the route indicated by the route information in a reverse direction correspond to the steering support.

Moreover, the control that is performed by the information providing unit 312 and that allows the display device 332 to sequentially display navigation messages N as the steering support information such that steering is performed in accordance with the route information, which will be described below, and the control that allows the display device 332 to sequentially display the navigation messages N as the steering support information to the worker for each operation such that the steering to return to the departure point S by tracing the route indicated by the route information in the reverse direction is performed correspond to the steering support. In addition, notifying the worker by voice or the like in place of the above-described control of displaying the messages also corresponds to the steering support.

### Controller: Load Control Unit

The winch control unit 315 calculates a load resulting from the suspended load L applied to the main hook 244 on the basis of the output of the load cell 321. Moreover, it is determined whether or not the load is equal to or larger than a rated total load, and in a case where the load is equal to or larger than the rated total load, an alarm signal is output to the alarm unit 341, and driving the main winding winch 241 and the derricking winch is stopped. When an alarm signal is input to the alarm unit 341, an alarm is generated.

### Controller: Work Range Setting Unit

As previously mentioned, in the crane body 20, the derricking angle of the boom 23 is limited within a certain angle range depending on the length of the boom 23, the weight of the suspended load L, and the like.

When the length of the boom 23 and the suspended load L are input by the input unit 331, the work range setting unit 313 calculates an appropriate range of the derricking angle of the boom 23, and sets the work range W composed of a rotating body in which the movable range of the main hook 244 and the suspended load L determined on the basis of a movable range of the boom 23 determined depending on the range of the derricking angle is rotated around a turning center axis of the rotating platform 22.

Then, the three-dimensional data of the boundary of the work range W is calculated and stored in the memory 36 as the work range information. This work range information is transmitted from the communication unit 35 depending on a request from the control unit 44 of the flying body 40.

Additionally, the work range setting unit 313 monitors the angle detected by the boom angle sensor 322 during the operation of the crane body 20 to limit pivoting operation so that the boom 23 can perform derricking pivoting only within an appropriate derricking angle range of the boom 23.

### Controller: Autonomous Control Unit

The autonomous control unit 311 requests and acquires, through the communication unit 35, the route information from the departure point S to the destination D for the transport of the suspended load L acquired by the flying body 40.

Moreover, the autonomous control unit 311 controls the control valve 38 that drives the turning hydraulic motor, the derricking hydraulic motor, and the main winding hydraulic motor such that the suspended load L is transported by tracing the route determined in the route information. Accordingly, in the autonomous operation mode, the winding and unwinding of the main winding winch 241, the turning of the rotating platform 22, and the pivoting operation of the boom 23 are performed, and the suspended load L is transported along the route determined in the route information from the departure point S to the destination D.

Additionally, when the suspended load L is transported to the destination D and the unslinging is ended, the autonomous control unit 311 controls the return operation of returning the main hook 244 to the departure point S by tracing the route indicated by the route information in the reverse direction. The control of the return operation may be started in accordance with an instruction from the input unit 331, or may be started when the load cell 321 or the like detects that the detected load has been reduced due to the unslinging of the suspended load L.

### Controller: Route Editing Unit

Since the route determined in the route information from the departure point S to the destination D in transporting the suspended load L is determined depending on the movement route by autonomous or voluntary steering of the flying body 40, there is a case where redundancy occurs in the route or an inappropriate portion occurs as the route of the crane body 20.

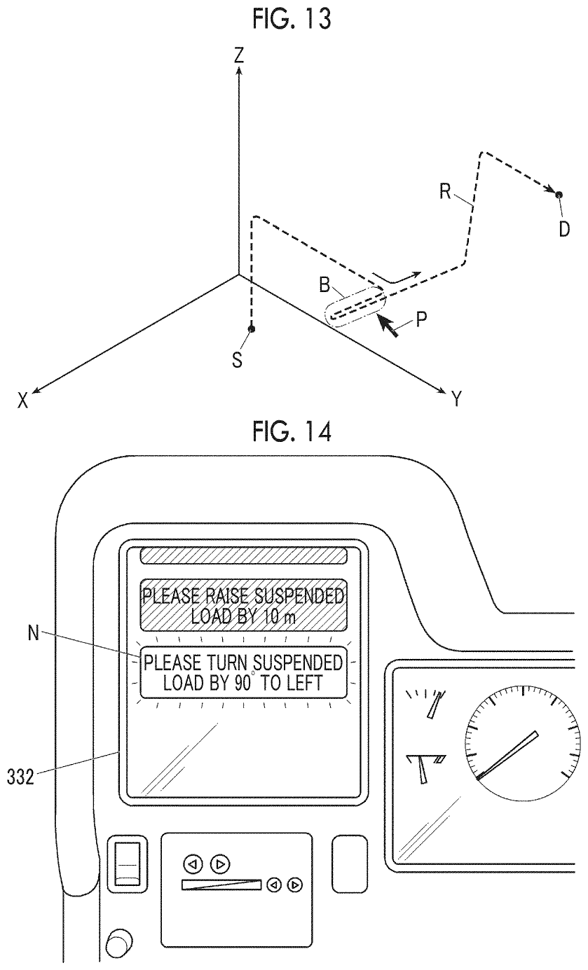

Thus, as shown in FIG. 13, the route editing unit 314 displays a route R and a pointer P determined in the route information on the display device 332, and executes the editing work of receiving the manipulation of specifying an editing target spot B such as a redundant portion in the route R with the pointer P from the input unit 331 to change the route R. Specifically, manipulations such as deleting the editing target spot B, short-circuiting two points on the route R, adding a route in the middle, and changing the direction of the route of the editing target spot B are received, and the route R is updated to the route R after the editing.

Accordingly, the crane body 20 can realize the transport operation of the suspended load L along a more appropriate route R.

### Controller: Information Providing Unit

As previously mentioned, the crane body 20 can execute the steering mode in which the suspended load L is transported in accordance with the steering by the worker on board.

When the steering mode is selected in the input unit 331 of the crane terminal 30, the turning operation of the rotating platform 22, the derricking pivoting operation of the boom 23, the winding and unwinding operation of the main winding winch 241 and the auxiliary winding winch 242 are executed in accordance with the manipulation of the manipulating lever 37.

Meanwhile, when the steering mode is selected, the information providing unit 312 requests and acquires the route information from the departure point S to the destination D in transporting the suspended load L with respect to the flying body 40 via the communication unit 35.

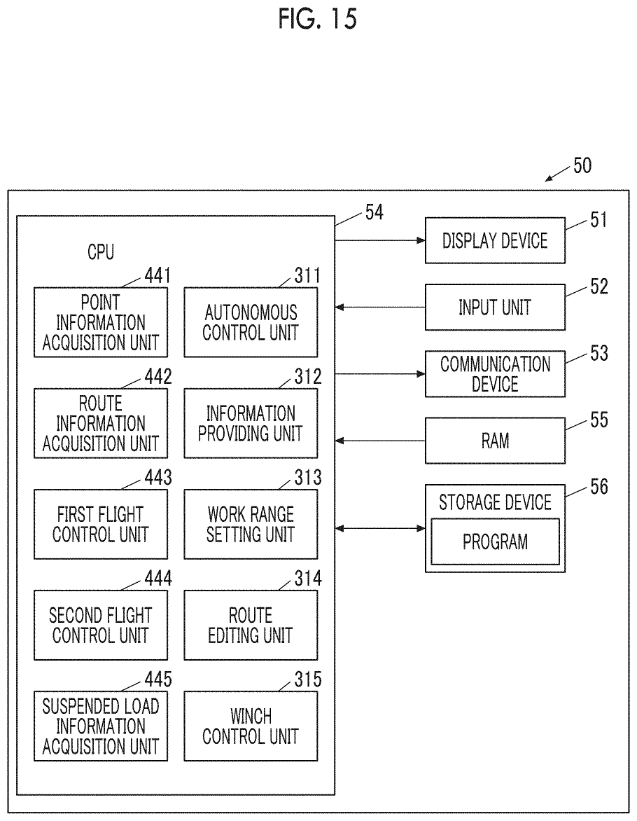

Then, as shown in FIG. 14, the information providing unit 312 sequentially displays the navigation messages N as the steering support information to the worker in the display device 332 for each operation such that the steering is performed in accordance with the route information from the departure point S to the destination D in transporting the suspended load L.

The information providing unit 312 detects the operation of an operation target portion of the crane body 20 via a sensor, and sequentially switches the display to the next navigation message when the operation indicated by one navigation message N is performed. Therefore, the crane body 20 can perform the transport operation in accordance with the route information from the departure point S to the destination D in transporting the suspended load L by sequentially performing the steering in accordance with the individual navigation messages N.

Additionally, the information providing unit 312 sequentially displays the navigation messages N as the steering support information to the worker in the display device 332 for each operation such that the steering to return to the departure point S by tracing the route indicated by the route information in the reverse direction is performed.

### Technical Effects of Embodiment of Invention

In the above crane 10, the route information acquisition unit 442 includes the autonomous control unit 311 that acquires the route information in transporting the suspended load L of the crane body 20 via the flying body 40 and that controls the transport operation of the crane body 20 along the movement route indicated by the route information.

Therefore, even in a case where the destination D is a place that is difficult to visually confirm from the crane body 20, it is possible to perform an appropriate transport operation of the suspended load L.

Additionally, similarly, even in a case where it is difficult to visually confirm the route to the destination D from the crane body 20, it is possible to perform an appropriate transport operation of the suspended load L.

Additionally, since the above flying body 40 includes the positional information acquisition unit 441 that acquires the information on the departure point S or the destination D for the transport of the suspended load L, the flying body 40 can be caused to fly to the set departure point S or the destination D, and it is possible to set the movement route more accurately.

Additionally, since the flying body 40 includes the first flight control unit 443 that executes the autonomous flight between the departure point and the destination for the transport of the suspended load L on the basis of the positional information, it is possible to reduce the work burden of setting the movement route by steering the flying body 40.

Additionally, even in a situation where it is difficult to visually confirm the entire route from the departure point S to the destination D from one spot, the steering is not required. Thus, it is possible to set an appropriate route.

Additionally, since the flying body 40 includes the second flight control unit 444 that detects the obstacle H around the flying body 40 via the camera 41 and that sets the interference area I centered on the flying body 40 on the basis of the size of the suspended load L obtained by the suspended load information acquisition unit 445 to cause the flying body 40 to execute the flight in which the interference area I does not interfere with the surrounding obstacle H, the route acquired by the flying body 40 makes it possible to suppress the interference between the suspended load L and the obstacle H and to realize favorable transport by the crane body 20.

Additionally, since the suspended load information acquisition unit 445 acquires the size of the suspended load L from the captured image of the suspended load L by the camera 41, it is possible to reduce the burden of the measurement work, and to acquire the suspended load information according to the actual size of the suspended load.

Additionally, since the route information acquisition unit 442 acquires the route information within the work range W as the flying body 40 flies in the work range W of the crane body 20, the crane body 20 can be operated without interfering with the work range W in accordance with the acquired route information, and it is possible to perform more appropriate transport work.

Additionally, since the autonomous control unit 311 of the crane terminal 30 executes the control of the return operation of returning the crane body 20 from the destination to the departure point by tracing the movement route indicated by the route information in the reverse direction, the crane body 20 can be rapidly shifted to the next transport work, and it is possible to improve the work efficiency.

Additionally, since the crane terminal 30 includes the route editing unit 314 that edits the movement route indicated by the route information, and the autonomous control unit 311 controls the transport operation of the crane body 20 along the movement route after the editing, the route acquired by the flight of the flying body 40 can be improved, and it is possible to transport the suspended load L on a more appropriate route.

Additionally, since the crane terminal 30 includes the information providing unit 312 that provides the steering support information such as navigation messages for performing the transport operation of the crane body 20 in accordance with the movement route indicated by the route information, even in a case where the worker manipulates the manipulating lever 37 to steer the crane body 20, it is possible to perform the transport work along the appropriate route acquired by the flying body 40.

### Other

In addition, the details shown in the embodiment of the above invention can be appropriately changed without departing from the scope of the invention.

For example, although the crawler crane has been exemplified as the above crane body 20, the present invention is not limited to this, and is applicable to any cranes such as harbor cranes, overhead cranes, jib cranes, portal cranes, unloaders, and the like, in addition to mobile cranes such as tower cranes, wheel cranes, and truck cranes.

Additionally, although a case where the camera 41 is mounted on the flying body 40 to acquire the route information has been exemplified, the present invention is not limited to this, and laser displacement sensors, ultrasonic sensors, or the like capable of detecting the three-dimensional shape of an object in front of the flying body 40 may be used.

Moreover, although a case where the camera 41 is mounted on the flying body 40 to acquire the route information has been exemplified, the present invention is not limited to this, and the camera 41 may be installed on the ground to image the flying body 40 that flies between the departure point S and the destination D and to calculate the position of the flying body 40 from the captured image to acquire the route information.

Additionally, in that case, a communication unit may be provided together in the camera 41 and be configured to transmit the captured image data to the outside to obtain the route information outside. Additionally, the communication unit of the camera 41 may be a data communication device capable of wireless communication only with the flying body 40, the crane terminal 30, and the steering device 49, or may be a data communication device that performs communication through a network line via a base station.

Additionally, although a case where the route information acquisition unit 442 and the first flight control unit 443 of the flying body 40 are based on the premise that the flying body 40 flies from the departure point S to the destination D has been exemplified, the flying body 40 may be caused to fly from the destination D to the departure point S. In that case, the route from the destination D to the departure point S is acquired as the route information. However, when the crane body 20 transports the suspended load L, the autonomous control unit 311 may control the crane body 20 so as to trace the route indicated by the route information in the reverse direction.

Additionally, although a case where the flying body 40 is selectable between the autonomous flight mode and the steering mode has been exemplified, the flying body 40 may be a flying body capable of executing only any one of the autonomous flight mode and the steering mode.

Additionally, the flight of the flying body 40 may not be performed in any one of the autonomous flight mode and the steering mode for a single flight.

For example, the flying body 40 may be caused to fly in a partial combination of the autonomous flight mode and the steering mode for the flight between the destination D and the departure point S. Specifically, the flying body 40 may fly in the steering mode around either or both of the departure point S and the destination D, and fly in the autonomous flight mode elsewhere.

Similarly, although a case where the crane body 20 is selectable between the autonomous operation mode and the steering mode has been exemplified, the crane body 20 may be capable of executing only any one of the autonomous operation mode and the steering mode.

Additionally, even in the case of the crane body 20, the work may be performed in a partial combination of the autonomous operation mode and the steering mode.

Additionally, as shown in FIG. 15, the crane 10 may include a computer 50 constituted by a server or the like capable of wireless communication or network communication outside the main crane body 20, and a CPU 54 provided in the computer 50 may be configured to execute some of the configurations performed by the control unit 44 of the flying body 40 or by the controller 31 of the crane terminal 30 instead of the control unit 44 or the controller 31.

As shown in FIG. 15, the computer 50 includes a display device 51 that display images, an input unit 52 that inputs various information by the worker, a communication unit 53, a CPU 54, a RAM 55, and a storage device 56.

Moreover, the CPU 54 has software modules that function as the positional information acquisition unit 441, the route information acquisition unit 442, the first flight control unit 443, the second flight control unit 444, the suspended load information acquisition unit 445, the autonomous control unit 311, the information providing unit 312, the work range setting unit 313, the route editing unit 314, and the winch control unit 315.

The above-described positional information acquisition unit 441, route information acquisition unit 442, first flight control unit 443, second flight control unit 444, suspended load information acquisition unit 445, autonomous control unit 311, information providing unit 312, work range setting unit 313, route editing unit 314, and winch control unit 315 are realized by the CPU 54 executing programs in the storage device 56.

In the case of the above configuration having the computer 50, the control unit 44 of the flying body 40 mainly transmits detection information of sensors that perform various detections of the flying body 40 and image data captured by the camera 41 to the computer 50, and executes the operation of the respective units on the basis of various commands received from the computer 50.

Additionally, similarly, the controller 31 of the crane terminal 30 also transmits detection information from sensors that perform various detections of the crane terminal 30 to the computer 50, and executes the operation of the respective units on the basis of various commands received from the computer 50. Additionally, the input performed by the input unit 331 of the crane terminal 30 may be input from the input unit 52 of the computer 50, and the display contents displayed on the display device 332 of the crane terminal 30 may be capable of being displayed on the display device 51 of the computer 50.

In addition, the computer 50 may be configured to function as only some of the positional information acquisition unit 441, the route information acquisition unit 442, the first flight control unit 443, the second flight control unit 444, the suspended load information acquisition unit 445, the autonomous control unit 311, the information providing unit 312, the work range setting unit 313, the route editing unit 314, and the winch control unit 315.

Additionally, as previously mentioned, in a case where the camera 41 is provided separately from the flying body 40, the camera 41 may be provided together in the computer 50, or the computer 50 may be capable of wired or wireless communication.

The present invention has industrial applicability to cranes, crane bodies, and programs.

It should be understood that the invention is not limited to the above-described embodiment, but may be modified into various forms on the basis of the spirit of the invention. Additionally, the modifications are included in the scope of the invention.

What is claimed is:

1. A crane comprising:
a crane body;
a flying body;
a route information acquisition unit that acquires route information in transporting a suspended load of the crane body via the flying body; and
a support unit that performs steering support for performing a transport operation of the crane body along a movement route indicated by the route information.

2. The crane according to claim 1,
wherein the flying body includes a positional information acquisition unit that acquires positional information of a destination or of a departure point for transporting the suspended load.

3. The crane according to claim 2,
wherein the flying body includes a first flight control unit that executes autonomous flight between the departure point and the destination for transporting the suspended load on the basis of the positional information.

4. The crane according to claim 1, further comprising:
an obstacle detection unit that detects an obstacle around the flying body;
a suspended load information acquisition unit that acquires a size of the suspended load; and
a second flight control unit that sets an interference area centered on the flying body on the basis of the size of the suspended load and that causes the flying body to execute a flight in which the interference area does not interfere with the surrounding obstacle.

5. The crane according to claim 4,
wherein the suspended load information acquisition unit acquires the size of the suspended load from a captured image of the suspended load by an imaging device provided in the flying body.

6. The crane according to claim 1,
wherein the route information acquisition unit acquires the route information within a work range of the crane body.

7. The crane according to claim 2,
wherein the support unit supports the crane body such that the crane body performs a return operation of returning from the destination to the departure point by tracing the movement route indicated by the route information in a reverse direction.

8. The crane according to claim 1, further comprising:
a route editing unit that edits the movement route indicated by the route information,
wherein the support unit supports the transport operation of the crane body along the movement route after the editing.

9. A crane body that performs steering support for performing a transport operation along a movement route indicated by route information in transporting a suspended load of the crane body, which is acquired by a flying body.

10. A non-transitory computer readable medium storing a program for causing a computer to function as:
a route information acquisition unit that acquires route information in transporting a suspended load of a crane body via a flying body; and
a support unit that performs steering support for performing a transport operation of the crane body along a movement route indicated by the route information.
